(19) United States
(12) Patent Application Publication
(10) Pub. No.: US 2006/0145464 A1
(43) Pub. Date: Jul. 6, 2006

(54) Gift book with gift indicia thereon

(76) Inventor: Henry Ostberg, Alpine, NJ (US)

Correspondence Address: GOTTLIEB RACKMAN & REISMAN PC, 270 MADISON AVENUE, 8TH FLOOR, NEW YORK, NY, 100160601, US

(21) Appl. No.: 11/030,521

(22) Filed: Jan. 6, 2005

(51) Int. Cl. B42D 1/00; B42D 5/00

(52) U.S. Cl. 281/15.1

(57) ABSTRACT

A book especially suited for gift giving for special occasions. The book has gift event indicia on its cover, as well as gift wrapping indicia. The contents of the book are also directed to the special occasion.

### FIELD OF THE INVENTION

The present invention relates generally to books and more specifically to books that are thematically related to specific events for which gifts are usually given.

### BACKGROUND OF THE INVENTION

It is often difficult to find an appropriate gift for birthdays, anniversaries, school graduations and other joyous occasions. Some gifts have become traditional for such events, including perfume for women, ties for men and writing instruments for graduating students. Books are often given as gifts for such events. However, it is often difficult to pick the right book for the right person for the right event. Often the gift recipient will already have read the book, or will not enjoy the subject matter of the book, and will then have to return it (if the stores accepts returns), causing further aggravation or possibly ill-will. There is therefore, a need for special books for special events, which are almost universal in appeal. Such books should be special and appropriate for each special occasion, and may serve as the primary gift or as a supplementary gift. These should be “self-wrapped”, i.e., not require “wrapping” by the gift giver or by a store, saving time and/or money for the gift giver.

### SUMMARY OF THE INVENTION

There is provided a book especially suited for a special occasion, such as a birthday or anniversary or like joyous a event, at which gifts are normally given and received with indicia thereon indicating such event, e.g., “happy birthday”. The book will also have indicia thereon, indicative of a gift wrapping, e.g., a ribbon, but the ribbon will be placed only on the cover and will not pass around the book. The contents of the book also directed to the special event.

### BRIEF DESCRIPTION OF THE DRAWINGS

FIG. 1 is a perspective view of a gift book with event identifying indicia and gift wrapping indicia, in accordance with the present invention;

FIG. 2 is a similar view, but with only the gift wrapping indicia thereon;

FIG. 3 is a front view thereof;

FIG. 4 is a side view or “spine” view thereof, but without any printing thereon;

FIG. 5 is a bottom view thereof;

FIG. 6 is a side view or “opening” side view thereof;

FIG. 7 is a top view thereof;

FIG. 8 is a back view thereof; and

FIG. 9 is a cross-sectional view thereof; taken along the line 9-9 of FIG. 3;

### DETAILED DESCRIPTION OF THE PREFERRED EMBODIMENT

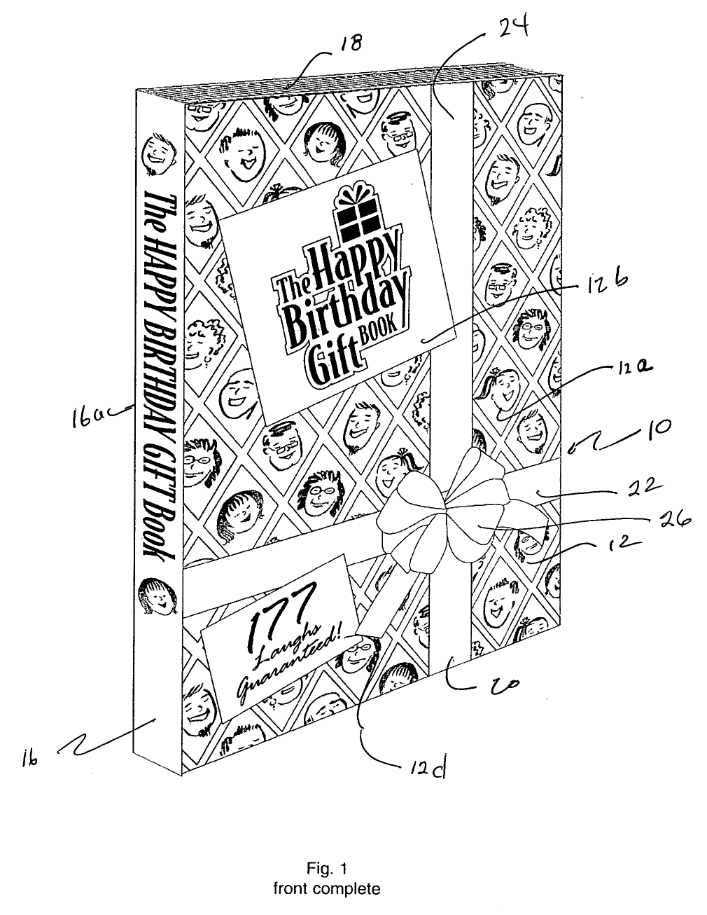

Referring now to the figures, FIG. 1 shows a gift book 10. Such a book has a top cover 12, preferably of a stiff paper or plastic stock, and a bottom cover 14, of similar stock. These covers are conventionally, but not necessarily, rectangular and co-extensive. These covers 12, 14 are joined in conventional fashion by a stiff spine 16. Captured within the covers and by the spine are a multitude of pages 18, the book as a whole being constructed by means well known in the book and bookbinding art.

A typical such gift book is related to a birthday, which is an event at which gifts are received by the person celebrating the event. Such book may be entitled “The Happy Birthday Gift Book”, this being indicative of the event being celebrated, and for which a gift is given. The content of such a book might include jokes relating to birthdays, poems relating to birthdays, cartoons relating to birthday events which have taken place on the birthday day but in prior years, and other written material, graphic or textual, relating to a birthday. Other examples of such gift books would include an anniversary book, an anniversary being another occasion on which gifts are received by the celebrants. Such an anniversary book might contain jokes and cartoons relating to anniversaries, frames in which anniversary pictures might be inserted, sayings and proverbs relating to anniversaries, and other graphic and textual, materials relating to anniversaries. Other occasions at which gifts are typically given and received might include high school or college graduation days, retirement occasions, family reunion days, religious holidays, confirmations, bar mitzvahs, and other days at which it is usual to give and receive gifts. In all cases, such a gift book will carry event identifying indicia such as shown at 12b, indicating the event being celebrated, and the contents of the book relate primarily or exclusively to the occasion being celebrated.

Referring specifically to FIG. 1, that figure shows “The Happy Birthday Gift Book” written on the book cover 12 at 12b and also including that saying on the spine at 16a. Other decorative material may also be imprinted on the cover 12, such as shown at 12a and 12d.

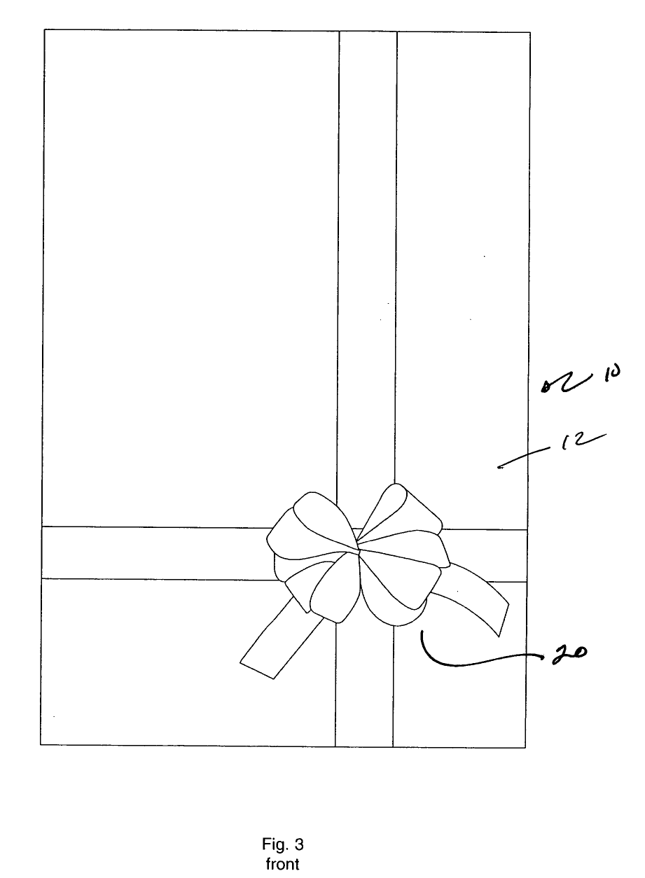

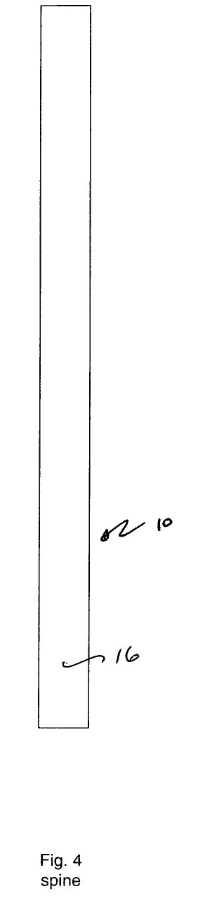

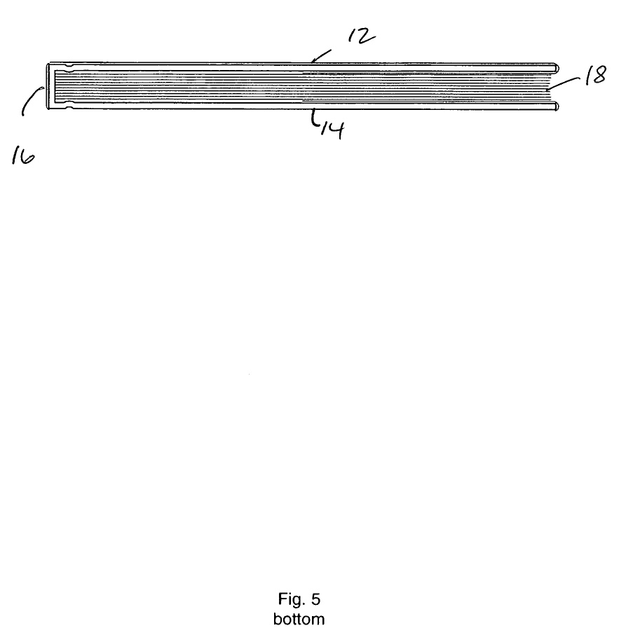

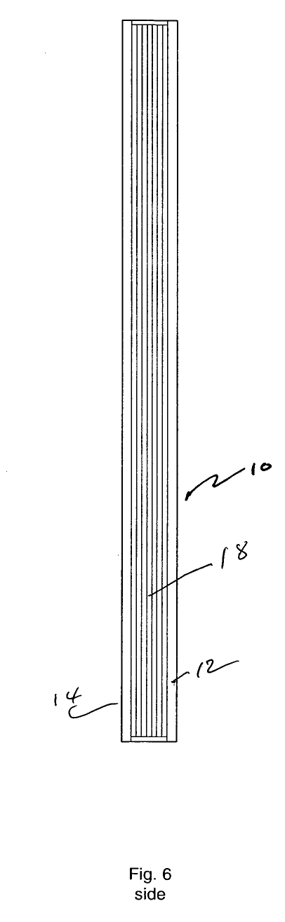

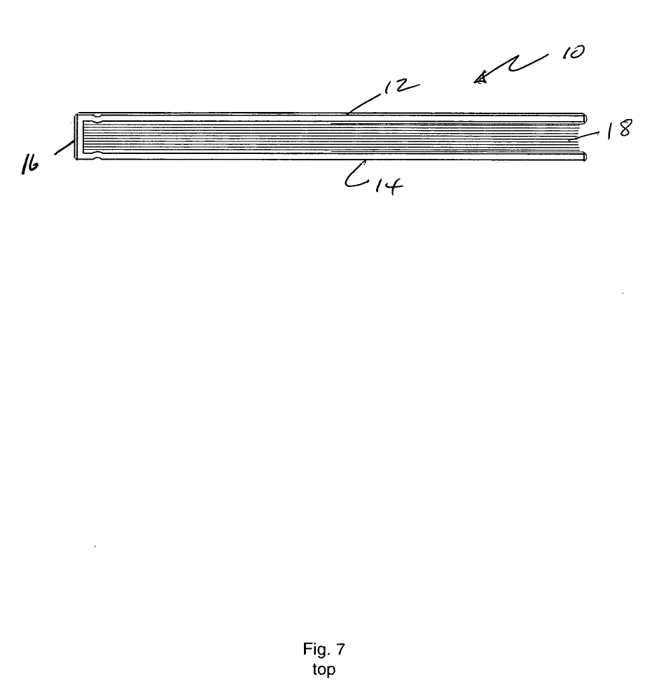

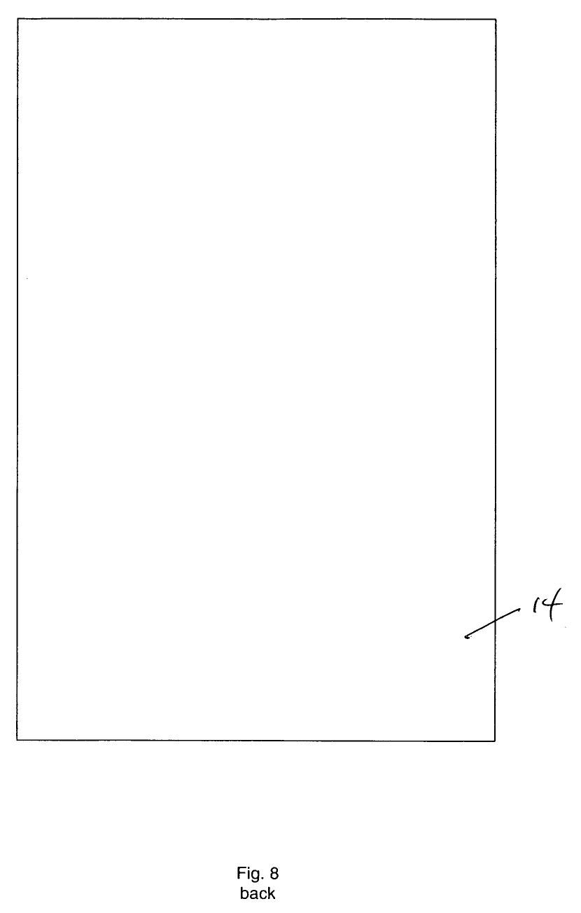

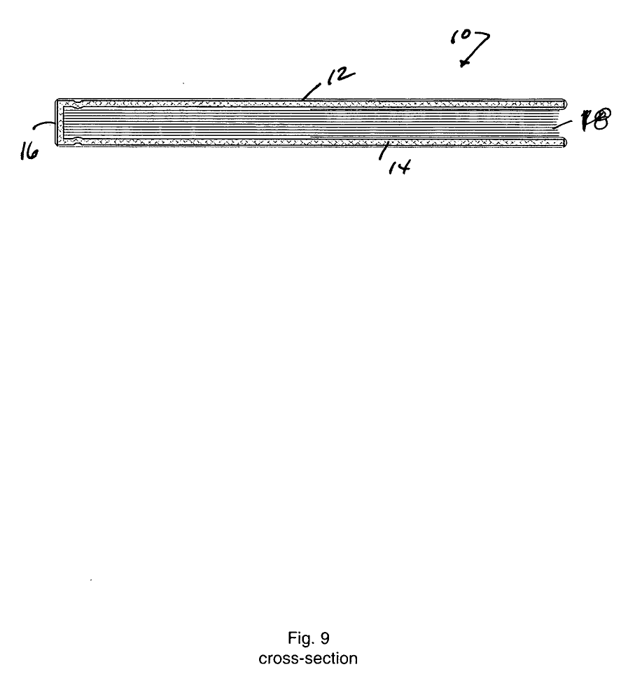

Most importantly, on the cover 12 is gift wrapping indicia, so that the book resembles an attractively wrapped gift package. The gift wrapping indicia may comprise a ribbon 20 including a cross ribbon member 22, a vertical ribbon member 24 and a bow 26. It should be noted that the ribbon 20 including its components 22, 24 and 26 desirably are not three dimensional with respect to the cover 12, but are simply applied to the cover as by direct printing on the cover. Furthermore, the ribbon 20 including its components, are displayed only on the cover of the book, and do not wrap around the entire book, see FIGS. 1-9.

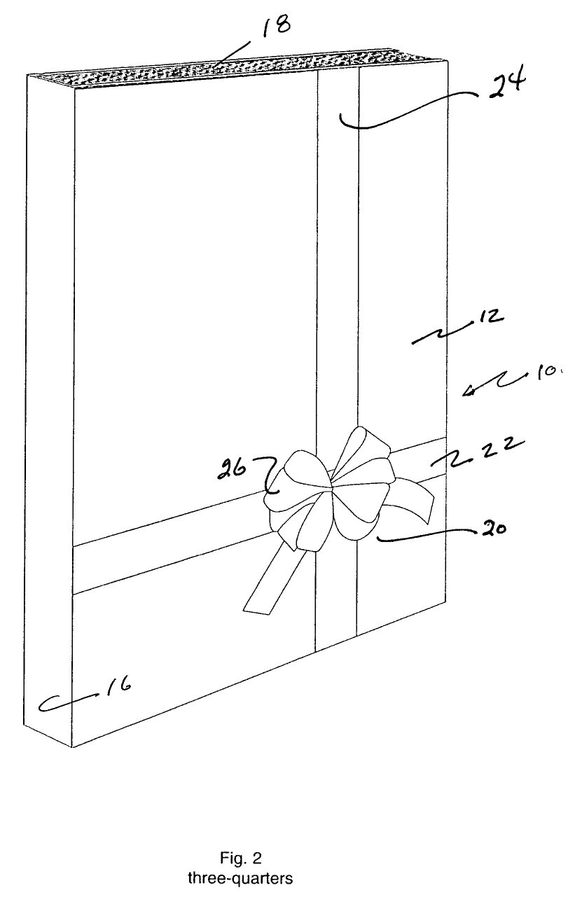

FIG. 2 for clarity shows the same gift book, but with only the gift wrapping indicia 20 printed thereon, i.e., without the event identifying indicia.

Thus, there is presented a book intended for a gift giving occasion, such as birthdays, anniversaries, weddings and the like, the content of which is primarily, thematically related to the occasion, including indicia on the book cover identifying the specific gift giving occasion or event, and also including gift wrapping indicia. Thereby, such an article may be sold at a retail location, and will be desirable as an “impulse” item to a consumer who can simply pick up the book and send it or bring it to an occasion on which gifts are given. Such a consumer does not have to wrap the package (or have the package “wrapped”) in the conventional manner, at a retail store, which is often time consuming and expensive. Rather, the book itself carries its own indicia, indicative of both the event being celebrated and of gift wrapping. Since the subject of the book is thematically linked to the event itself, it is highly likely that the recipient will enjoy it, since it focuses on his or her event.

1. A book intended to be given to a recipient on an occasion at which gifts are traditionally received, comprising;
a front cover,
a back cover,
a spine affixed to said front cover and said back cover, and
a multitude of pages affixed to the spine carrying text and/or graphic material primarily relating to the occasion, the book carrying at least one printed indicia identifying the event for which the book is to be given and a cover carrying printed gift wrapping indicia.

2. A book as set forth in claim 1 wherein the gift wrapping indicia is carried only on the front cover of the book, and does not pass around the other elements of the book.

3. A book as set forth in claim 2 wherein the gift wrapping indicia comprises a ribbon.

4. A book as set forth in claim 2 wherein said at least one event identifying indicia is carried on the spine of the book.

5. A book as set forth in claim 2 wherein the contents of the book relate exclusively to said occasion.

6. A book configuration for a book relating to a gift receiving occasion, comprising:
A cover carrying gift wrapping indicia, gift identifying indicia on said book, and the contents of said book relating exclusively to said occasion.
